(19) United States
(12) Patent Application Publication
(10) Pub. No.: US 2026/0024224 A1
(43) Pub. Date: Jan. 22, 2026

(54) UNIFIED MODEL FOR 3D OBJECT DETECTION AND OBJECT-CENTRIC NEURAL RECONSTRUCTION

(71) Applicant: Robert Bosch GmbH, Stuttgart (DE)

(72) Inventors: Yuliang GUO, Palo Alto, CA (US); Cheng ZHAO, Milpitas, CA (US); Ruoyu WANG, Sunnyvale, CA (US); Xinyu HUANG, San Jose, CA (US); Liu REN, Saratoga, CA (US)

(21) Appl. No.: 18/776,939

(22) Filed: Jul. 18, 2024

(51) Int. Cl. G06T 7/70

(52) U.S. Cl. CPC G06T 7/70; G06T 2207/20081; G06T 2207/30244; G06T 2207/30252

(57) ABSTRACT

A method of performing pose estimation for images includes, at one or more processing devices, receiving an input image, generating, based on the input image, a pose code that corresponds to an estimate pose of an object in the input image, generating a box code corresponding to a bounding box of the object in the input image, performing pose estimation for the input image by generating a refined pose of the object using the pose code and the box code, generating a prediction output for the object in the input image based on the input image and the refined pose, and controlling one or more functions of a device based on the prediction output.

### TECHNICAL FIELD

The present disclosure relates to artificial intelligence (AI) techniques for image recognition and processing.

### BACKGROUND

Various systems are configured to perform tasks using machine learning (ML) or other artificial intelligence (AI) techniques. For example, systems configured to perform image recognition, object detection, and/or other automated tasks may implement AI techniques. As one example, image detection systems and methods use various detection models trained for object and feature detection.

### SUMMARY

A method of performing pose estimation for images includes, at one or more processing devices, receiving an input image, generating, based on the input image, a pose code that corresponds to an estimate pose of an object in the input image, generating a box code corresponding to a bounding box of the object in the input image, performing pose estimation for the input image by generating a refined pose of the object using the pose code and the box code, generating a prediction output for the object in the input image based on the input image and the refined pose, and controlling one or more functions of a device based on the prediction output.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods. Further embodiments include a machine that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

FIG. 1 generally illustrates a system for training a machine learning model according to the principles of the present disclosure.

FIG. 2 generally illustrates a computer-implemented method for training and implementing a machine learning model according the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIG. 4A illustrates an example overall processing pipeline for a vision model according to the principles of the present disclosure.

FIG. 4B illustrates an example pose estimation module according to the principles of the present disclosure.

FIG. 4C illustrates an example unified model or pipeline for both training and inference according to the principles of the present disclosure.

FIG. 4D illustrates steps of an example method for implementing (e.g., training and subsequently performing pose estimation with) a vision model according to the principles of the present disclosure.

FIG. 5 illustrates a schematic diagram of an interaction between a computer-controlled machine and a control system according to the principles of the present disclosure.

FIG. 6 illustrates a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 illustrates a schematic diagram of the control system of FIG. 5 configured to control a manufacturing machine, such as a punch cutter, a cutter or a gun drill, of a manufacturing system, such as part of a production line.

FIG. 8 illustrates a schematic diagram of the control system of FIG. 5 configured to control a power tool, such as a power drill or driver that has an at least partially autonomous mode.

FIG. 9 illustrates a schematic diagram of the control system of FIG. 5 configured to control an automated personal assistant.

FIG. 10 illustrates a schematic diagram of the control system of FIG. 5 configured to control a monitoring system, such as a control access system or a surveillance system.

FIG. 11 illustrates a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

As used herein, “content” may refer to original content corresponding to the input data (e.g., data representative of a captured image, video, sound, text, etc.) or synthesized content (e.g., a synthesized image, video, sound, text, etc.). In some examples, “content” may include images, which may correspond to captured images, synthesized images, or combinations thereof. Images may be represented by image data. In some contexts herein, the terms “image” and “image data” may be used interchangeably and may refer to actual pixel values, color channels, vectors, and/or binary data corresponding to visual content of an image. In an example, “image” and/or “image data” refer to a raw representation of an image, such as an array of numerical values representing pixel intensities, which in some examples may include preprocessed data that originated from an image sensor. Conversely, “metadata” or “image metadata” may refer to contextual or supplementary details about the image, such as image size, format, creation date, geolocation data, and the like. In various examples, an “image” and “image data” may, but do not necessarily, further include metadata.

Various systems are configured to perform tasks using machine learning (ML) or other artificial intelligence (AI) techniques (e.g., ML or other AI models). For example, systems configured to perform image recognition, object detection, and/or other automated tasks may implement AI techniques. As one example, image detection systems and methods use various detection (e.g., vision models) models trained for object and feature detection.

Some vision models are configured generate images of 3-dimensional (3D) objects from 2-dimensional (2D) images (e.g., reconstruct a 3D object from a single 2D image), which may be referred to as single view 3D object reconstruction. Single view 3D object reconstruction is a critical technology with broad applications, including, but not limited to, autonomous driving, augmented reality/virtual reality (AV/VR) systems, robotics, and embodied AI. Single view 3D object reconstruction techniques are limited by constraints of a primary data source, which may include sparse views and dynamic objects.

Vision models may implement Neural Radiance Field (“NeRF”) techniques to perform 3D reconstruction, which offer specific advantages in presenting scenes at fine resolutions and generating novel-view images from reconstructed scenes. In some examples, object-centric NeRF techniques further enhance the flexibility of novel data synthesis. However, object-centric NeRF methods impose strict requirements for multi-view observations and accurate object poses and/or or heavily depend on third-party object detection to provide initial object poses. The reliance on external 3D object detection introduces computational overhead in both training and deployment.

Systems and methods according to the present disclosure implement a vision model configured to perform unified object-centric reconstruction (e.g., object-centric NeRF 3D reconstruction) techniques. In particular, the systems and methods described herein combine object-centric neural reconstruction and pose estimation to obtain a more efficient and generalizable reconstruction result. In an example, the vision module includes, implements, includes, and/or communicates with a post estimation module configured to generate, for an object in an input image, updated pose data (a “refined pose” or “refined pose data”) from the input image and an input/current pose of the object (i.e., a pose of the object as shown in the input image). As used herein, “pose” refers to a position and orientation of an object in 3D space relative to a camera. As used herein, “the camera” may refer to the camera that captured the image. Accordingly, an estimated or calculated pose or pose data may include coordinates (e.g., X, Y, and Z coordinates in a 3D coordinate space), angles heatmaps, bounding boxes (with a rotation/rotation angle), etc. defining the pose of the object. In examples described herein, the pose or pose data includes bounding boxes. “Refined” poses, differentiated from the input or current pose, are predicted or calculated poses (and/or corresponding pose data) for different ranges (i.e., distances from the object), angles, orientations, etc.

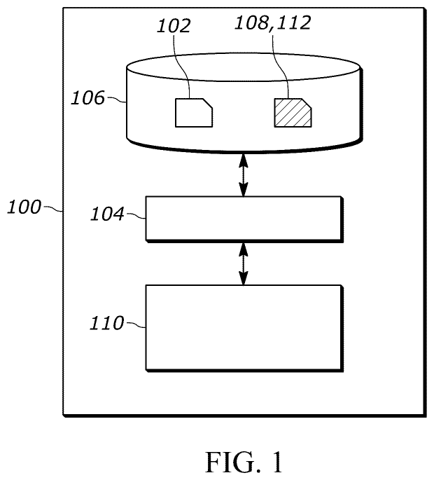

FIG. 1 shows one example system 100 for training of an ML or other AI model, such as a vision model according to the present disclosure. As used herein, for simplicity, “vision” model may refer to a pose estimation model or module, a vision model configured to perform pose estimation in accordance with the techniques of the present disclosure, etc. The system 100 may be configured to (and/or include circuitry configured to) implement the systems and methods of the present disclosure described below in more detail. The system 100 may comprise an input interface for accessing training data 102 for the vision model. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the vision model which may be accessed by the system 100 from the data storage 106. It will be appreciated, however, that the training data 102 and the data representation 108 of the untrained vision model may also each be accessed from different data storage, e.g., via a different subsystem of the data storage interface 104. Each subsystem may be of a type as is described above for the data storage interface 104.

In some embodiments, the data representation 108 of the untrained vision model may be internally generated by the system 100 on the basis of design parameters for the vision model, and therefore may not explicitly be stored on the data storage 106. The system 100 may further comprise a processor subsystem 110 which may be configured to, during operation of the system 100, provide an iterative function as a substitute for a stack of layers of the vision model to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the vision model using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the vision model. The processor subsystem 110 is configured to train the vision model in accordance with systems and methods of the present disclosure as described below in more detail.

The system 100 may further comprise an output interface for outputting a data representation 112 of the trained vision model. This data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ vision model may, during or after the training, be replaced, at least in part by the data representation 112 of the trained vision model, in that the parameters of the vision model, such as weights, hyperparameters and other types of parameters of vision models, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ vision model. In some embodiments, the output interface may be separate from the data storage interface 104, but may in general be of a type as described above for the data storage interface 104.

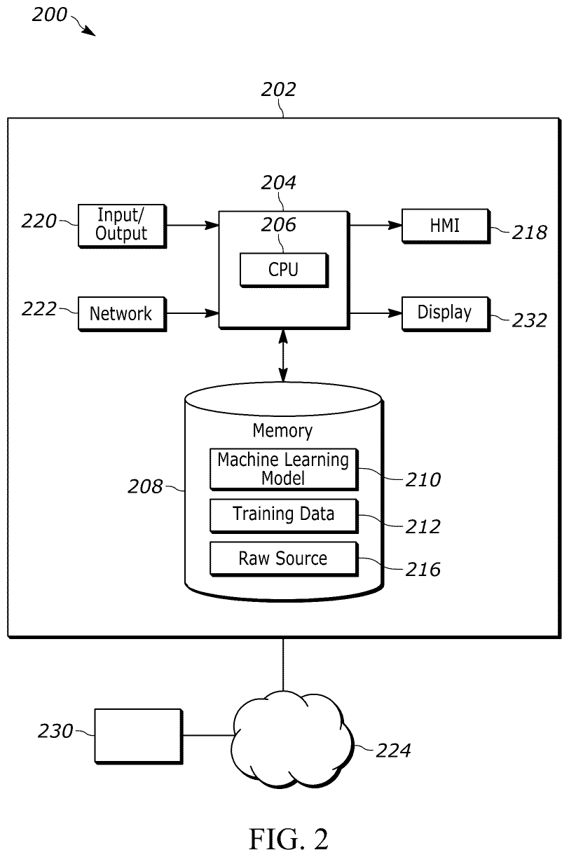

FIG. 2 depicts an example content generation system 200 configured to (and/or including circuitry configured to) implement a system for, annotating, augmenting, and/or generating data. The content generation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store one or more machine learning models (e.g., represented in FIG. 2 as the machine learning model 210) or algorithms, a training dataset 212 for the machine learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement the machine learning model 210 to analyze the raw source dataset 216. For example, the CPU 206 and/or other circuitry may implement the machine learning model 210. The raw source dataset 216 may include raw or unprocessed sensor data that may be representative of an input dataset for a machine learning system. The raw source dataset 216 may include images, video, video segments, audio, text-based information, and raw or partially processed sensor data (e.g., a radar map of objects). In some embodiments, the machine learning model 210 may include a deep-learning or neural network algorithm that is designed to perform a predetermined function. For example, the neural network algorithm may be configured to identify events or objects in images or video segments based on audio data.

The computer system 202 may store the training dataset 212 for the machine learning model 210. The training dataset 212 may represent a set of previously constructed data for training the machine learning model 210. The training dataset 212 may be used by the machine learning model 210 to learn various conditions and other factors (e.g., weighting factors) associated with an ML algorithm. The training dataset 212 may include a set of source data that has corresponding outcomes or results that the machine learning model 210 tries to duplicate via the learning process.

The machine learning model 210 may be operated in a learning mode using the training dataset 212 as input. The machine learning model 210 may be executed over a number of iterations using the data from the training dataset 212. With each iteration, the machine learning model 210 may update internal weighting factors based on the achieved results. For example, the machine learning model 210 can compare output results (e.g., generated content) with those included in the training dataset 212. Since the training dataset 212 includes the expected results, the machine learning model 210 can determine when performance is acceptable. After the machine learning model 210 achieves a predetermined performance level (e.g., 100% agreement with the outcomes associated with the training dataset 212), the machine learning model 210 may be executed using data that is not in the training dataset 212. The trained machine learning model 210 may be applied to new datasets to generate content. The machine learning model 210 may include a vision model trained in accordance with systems and methods of the present disclosure.

The machine learning model 210 may be configured to identify a particular feature in the raw source data 216. The raw source data 216 may include a plurality of instances or input dataset for which output results are desired (e.g., an image, a video stream or segment including audio data, etc.). For example only, the machine learning model 210 may be configured to identify objects or features in an image, objects or events in a video segment based on audio data, etc. In some examples, the machine learning model 210 may be configured to annotate identified objects, features, or events. The machine learning model 210 may be configured to perform pose estimation according to the principles of the present disclosure. The machine learning model 210 may be programmed to process the raw source data 216 to identify the presence of the particular features. The machine learning model 210 may be configured to identify a feature in the raw source data 216 as a predetermined feature. The raw source data 216 may be derived from a variety of sources. For example, the raw source data 216 may be actual input data collected by a machine learning system. The raw source data 216 may be machine generated for testing the system. As an example, the raw source data 216 may include raw image data, raw video and/or audio data from a camera, audio data from a microphone, etc.

In an example, the machine learning model 210 may process raw source data 216 and output video and/or audio data including one or more indications of an identified event. The machine learning model 210 may generate a confidence level or factor for each output generated. For example, a confidence value that exceeds a predetermined high-confidence threshold may indicate that the machine learning model 210 is confident that the identified event (or feature) corresponds to the particular event. A confidence value that is less than a low-confidence threshold may indicate that the machine learning model 210 has some uncertainty that the particular feature is present.

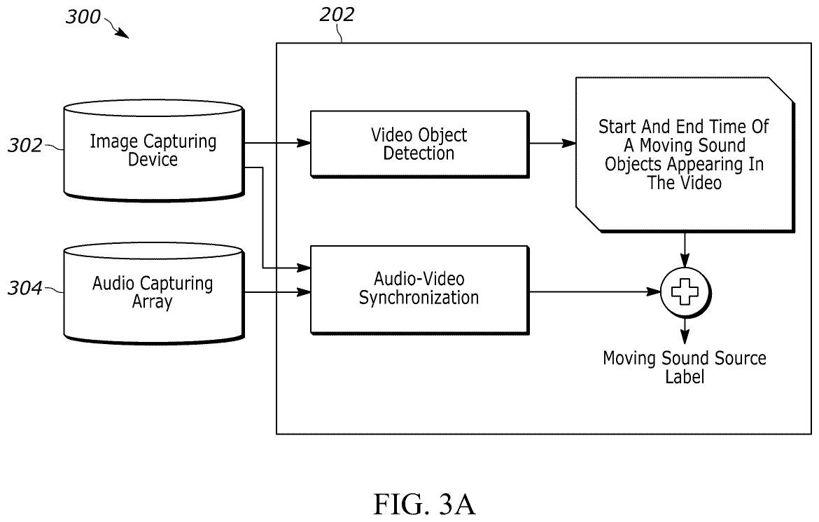

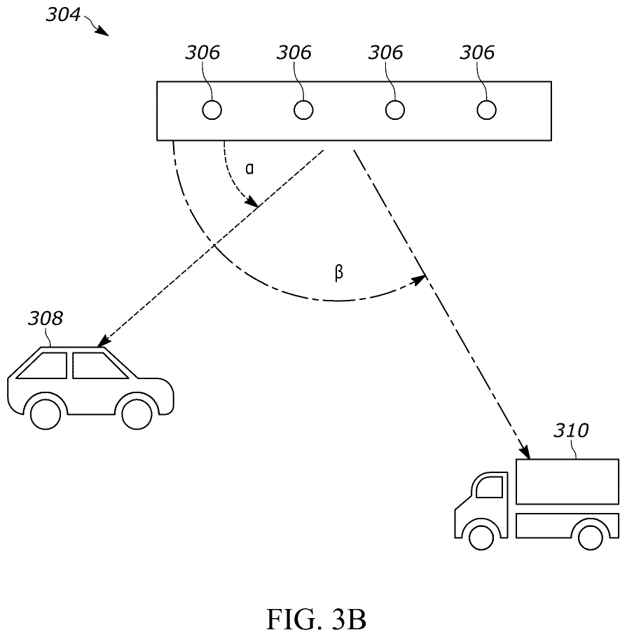

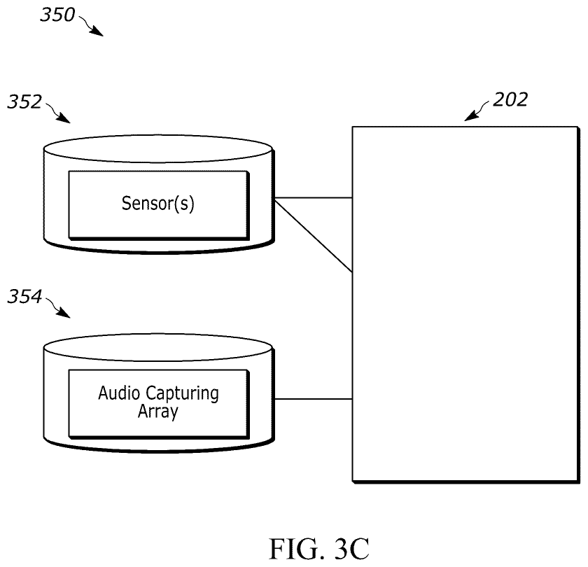

As is generally illustrated in FIGS. 3A and 3B, an example system 300 may include an image (e.g., image and/or video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine learning model (e.g., such as the machine learning model 210 or other suitable machine learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

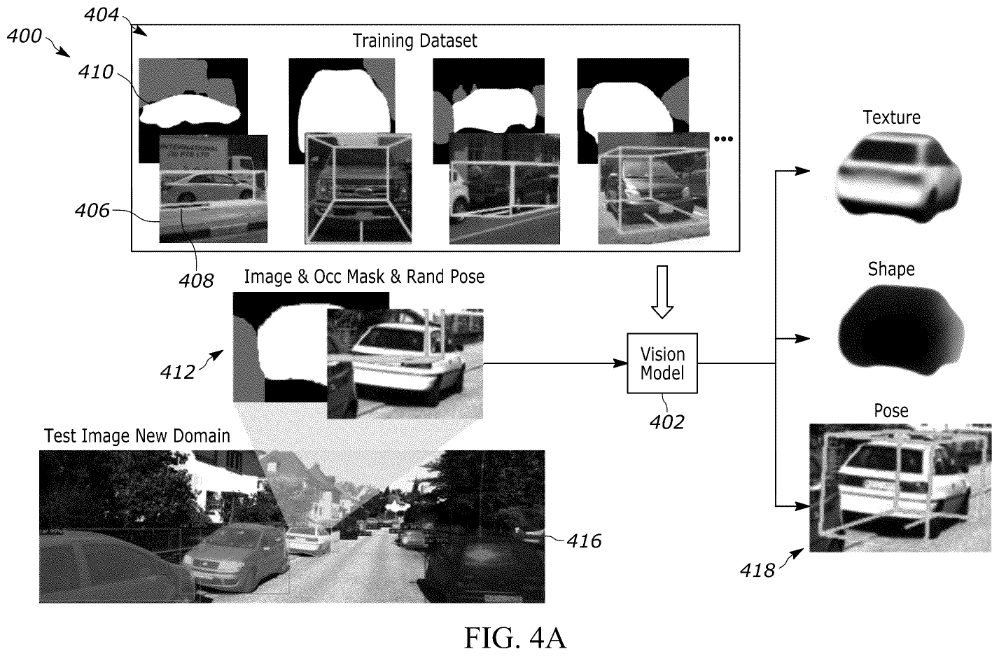

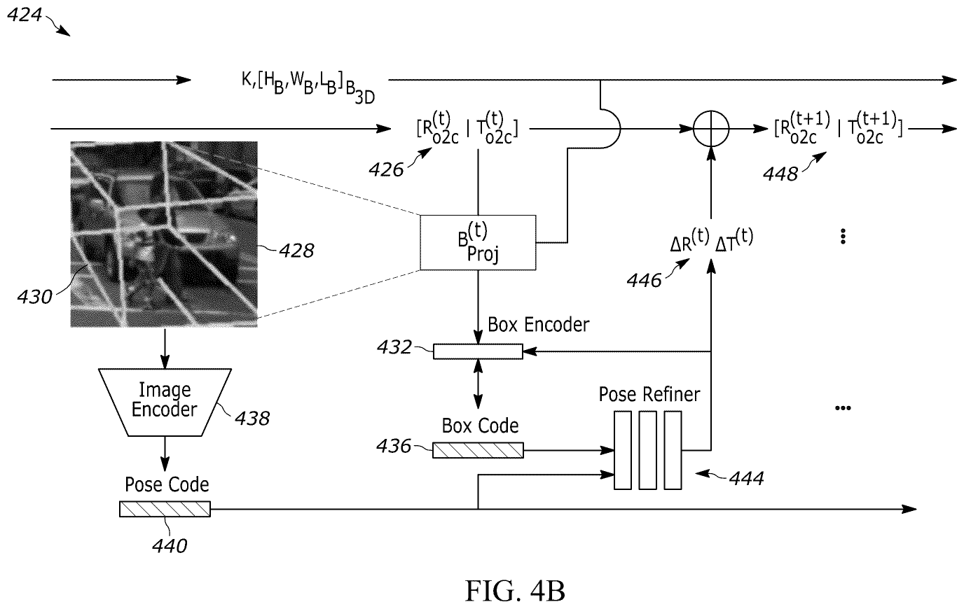

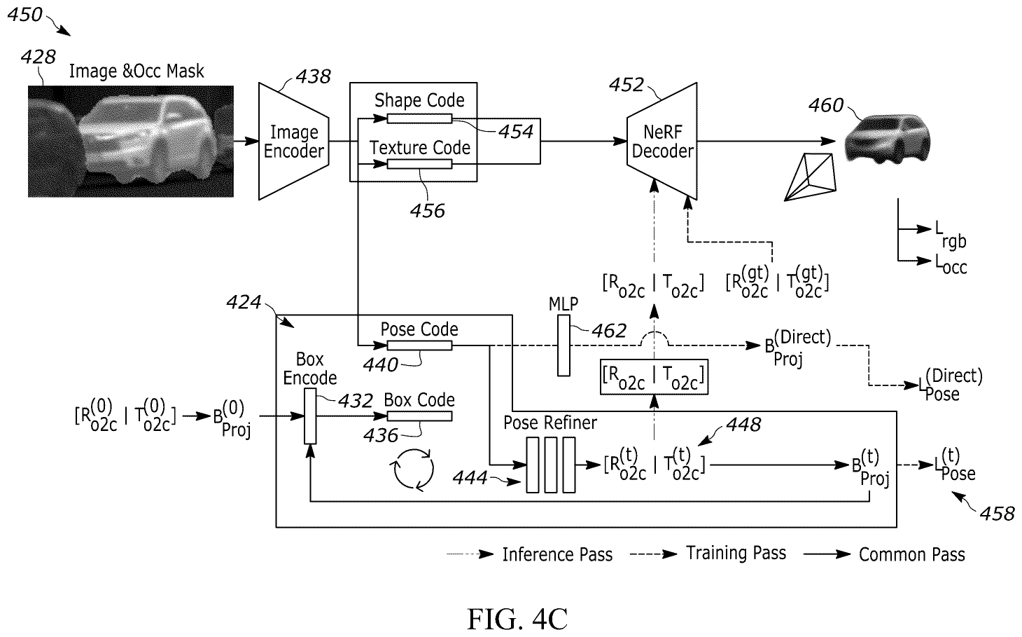

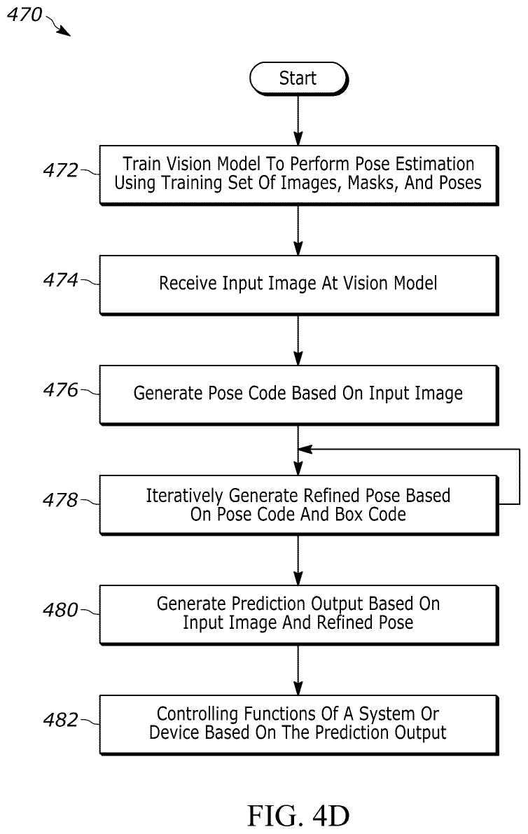

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine learning model using the training data. The system 202 may detect, using the second machine learning model, one or more sounds associated with audio data provided as input to the second machine learning model. The second machine learning model may include any suitable machine learning model and may be configured to perform any suitable function, such as those described herein with respect to FIGS. 4-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine learning model using the training data. The system 202 may detect, using the second machine learning model, one or more sounds associated with audio data provided as input to the second machine learning model. The second machine learning model may include any suitable machine learning model and may be configured to perform any suitable function, such as those described herein with respect to FIGS. 4-11.

The systems and methods of the present disclosure (e.g., any of the systems 100, 200, etc.) are configured to train a vision model (e.g., the model 210) to perform pose estimation and to generate refined poses using the vision model as described below in more detail. The techniques of the present disclosure may be referred to as Unified NeRF (“UPNeRF”) techniques, which provide a unified solution that jointly predicts a pose, shape, and texture of an observed object from a single network. The vision model of the present disclosure can be trained using actual scenes (e.g., actual driving scenes) with inaccurate predicted labels.

FIG. 4A illustrates an example overall processing pipeline 400 for a vision model 402 (e.g., an UPNeRF vision model) configured to perform pose estimation according to the present disclosure. For example, one or more computing devices, processors, or processing devices are configured to execute instructions to implement the functions of the pipeline 400, such as one or more of the processors of the systems (e.g., 100, 200, etc.) described herein.

The vision model 402 is trained with a training dataset 404. The training dataset 404 includes a plurality of input images 406 (e.g., 2D images of objects, such as vehicles) and corresponding poses of the objects, represented in this example as bounding boxes 408 with rotation. As used herein, “with rotation” refers data/values indicating one or more rotation angles of the bounding box 408. For example, the rotation angles indicate an orientation of the bounding box 408 (and the object) relative to the camera, the ground, etc. The bounding box 408 may be defined by data/values identifying one or more corners (e.g., using X, Y, and Z) coordinates, a width and/or length of the bounding box 408, etc. In some examples, the training dataset 404 further include shapes 410 or shape data. The shapes 410 provided along with the images 406 indicate an overall shape, outline, form, etc. of the objects in the images 406.

During and/or subsequent to training, the vision model 402 is provided with test images 412 (e.g., sets of test images of objects extracted from a scene 416). As shown, the test images 412 may be provided to the vision model 402 along with, as additional inputs, occlusion masks, a random pose (e.g., a bounding box representing a random pose), etc. The vision model 402 is configured to generate and output, based on the test images 412, features such as texture, shape, and a refined pose of the objects in the test images as shown at 418.

FIG. 4B illustrates an example pose estimation module 424 according to the present disclosure. As used herein, the pose estimation module 424 may correspond to a model executed by the vision model 402, a model separate from the vision model 402, circuitry configured to perform pose estimation functions or techniques, etc. For example, one or more computing devices, processors, or processing devices are configured to execute instructions to implement the functions of the pose estimation module 424, such as one or more of the processors of the systems (e.g., 100, 200, etc.) described herein. The pose estimation module 424 is configured to provide reliable poses for target objects in multiple ranges and orientations, and perform robustly under various conditions (e.g., for occluded images in which at least a portion of the target object is occluded/obscured).

As shown in FIG. 4B, the pose estimation module 424 iteratively updates an input pose 426 based on a visual difference between the input pose 426 and an observed object in an input image 428. Given dimensions [H_{B}, W_{B}, and L_{B}] (e.g., height, width, and length, respectively) of an object, a camera intrinsic K, and a current pose (t), (t) (corresponding to rotation and translation, respectively), the pose estimation module 424 obtains image projections of 3D box corners (t) (e.g., coordinates of eight corners of a bounding box 430). The box corners (t) correspond to a visual representation of the current (i.e., input) pose 426. In an example, (t) is a 16-bit vector. A box encoder 432 encodes (t) to generate a box code 436. For example, the box code 436 corresponds to a higher-dimensional code or vector based on (t). In an example, the box code 436 is 255-bit vector or other representation of (t).

The input image 428 is provided to an image encoder 438. The image encoder 438 is configured to generate and output an estimated pose, such as a pose code 440, based on the input image 428. For example, the pose code 440 is a code value or vector corresponding to the estimated pose. In an example, the post code 400 is a lower-dimensional code or vector (e.g., compressed) representation of the estimated pose obtained using principal component analysis (PCA) or other technique.

The box code 436 and the pose code 440 are provided as inputs to a pose refiner 444. The pose refiner 440 is configured to predict a pose update 446 or pose changes Δ(t), ΔT(t), which represents respective changes to R(t) and T(t) of the input pose 426. The pose update 446 is combined with the input pose 426 to obtain a next (refined or updated) pose or pose state 448 (R^{(t+1)}, T^{(t+1)}). Generation of the pose update 446 and the updated pose 448 is repeated over multiple iterations (e.g., by providing the pose update 446 to the box encoder 432, which updates the box code 436 based on the pose update 446. The pose estimation module 424 continues to generate the pose update 446 and the updated pose 448 until a final pose state is obtained.

FIG. 4C illustrates an example unified model or pipeline 450 (e.g., a pipeline of a vision model) according to the present disclosure. For example, one or more computing devices, processors, or processing devices are configured to execute instructions to implement the functions of the unified pipeline 450, such as one or more of the processors of the systems (e.g., 100, 200, etc.) described herein. The unified pipeline 450 illustrates both training of the vision model and inference functions performed by the vision model. For example, as shown in FIG. 4C, training and inference process flows are indicated by respective dashed lines and flows common to both training and inference process are indicated by solid lines.

The pipeline 450 includes the image encoder 438 (e.g., a residual network (ResNet)-based image encoder), the pose estimation module 424, and a NeRF decoder 452. The image encoder 438 receives the input image 428 (and an associated occlusion mask, together referred to as a masked input image). The image encoder 438 translates the masked input image 428 into a shape code 454 and a texture code 456 (e.g., respective code values or vectors corresponding to estimated shape and texture) and the pose code 440. The pose code 440, along with box code 436, are provided the pose refiner 444 as described above to iteratively refine an object pose R_{o2c}|T_{o2c}. After multiple iterations, an estimated pose can either be converted to a camera pose R_{c2o}|T_{c2o} and input to the NeRF decoder 452 for inference tasks or used to calculate pose losses (L) during training as shown at 458.

During inference tasks, the NeRF decoder 452 generates, based on the shape code 454, the texture code 456, and the updated pose 448, a prediction output 460, which identifies detected objects within the input image, corresponding bounding boxes, etc. In an example, the NeRF decoder 452 performs volumetric rendering to generate an RGB image (e.g., rendered RGB values) and an occupancy image (e.g., aggregated occupancy values). The rendered RGB values are compared to the input image 428 to compute a photometric loss L_{rgb}, and the aggregated occupancy values are compared to the occupancy mask received with the input image 428 to obtain an occupancy loss L_{occ}. A total loss L_{infer} can be obtained in accordance with L_{infer}=L_{rgb}+w_{occ}L_{occ}, where w_{occ} is a weight coefficient configured to balance the two loss terms L_{rgb} and L_{occ}. The loss L_{infer} is used to update optimizable variables of the NeRF decoder 542, which are defined differently for inference and training.

In an example, the pipeline 450 may include one or more multilayer perceptrons (MLPs) 462. For example, the MLP 462 is configured to, during training, convert the pose code 440 to a higher-dimension code or vector, which can be used to obtain a direct pose loss

$${L}_{pose}^{( direct )} .$$

Conversely, the output of the pose refiner 444 can be used to obtain a pose loss

$${L}_{pose}^{( t )} .$$

By unifying object detector and object-centric neural reconstruction in the manner described above, the vision model according to the present disclosure significantly improves computational efficiency and generalization capabilities.

FIG. 4D illustrates steps of an example method 470 for implementing (e.g., training and subsequently performing pose estimation with) a vision model according to the principles of the present disclosure. For example, one or more processors or processing devices are configured to execute instructions to implement the method 450, such as one or more of the processors of the systems described herein.

At 472, the method 470 includes training a vision model to perform pose estimation using a training set of images, masks, and poses (e.g., pose information or data, such as bounding boxes). Training the vision model includes training the pose estimation module 424 as described above in FIGS. 4A-4C.

At 474, the method 470 includes receiving an input image at the vision model. At 476, the method 470 includes generating a pose code based on the input image. At 478, the method 470 includes iteratively generating a refined pose based on the pose code and a box code. For example, the method 470 may repeat step 476 to refine the pose (e.g., until a pose loss is below a threshold). At 480, the method 470 includes generating (e.g., using a NeRF decoder as described herein) a prediction output based on the input image (e.g., based on a shape code and a texture code) and the refined pose.

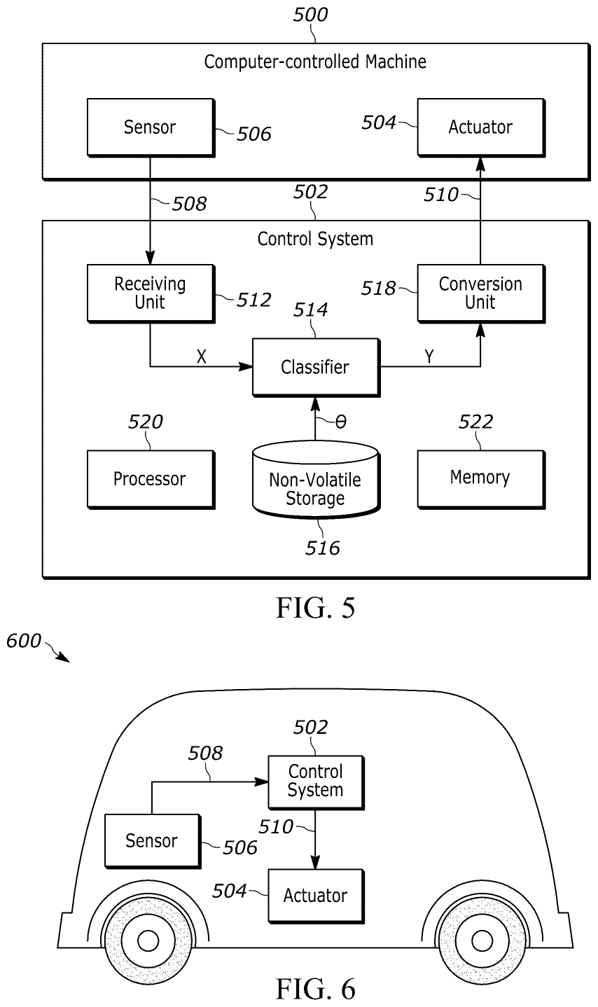

At 482, the method 470 includes controlling one or more functions of a system, device, machine, etc. based on the prediction output and refined pose. For example, the prediction output and refined pose can be used for various downstream object detection and image recognition tasks, such as control of autonomous vehicles, robotics, AR/VR systems, etc. In some examples, the method 470 includes controlling functions of any of the systems described below in FIGS. 5-11.

FIGS. 5-11 depict example systems and devices that may implement vision models, such as pose estimation models, vision models configured to perform pose estimation, etc., according to the present disclosure. FIG. 5 depicts a schematic diagram of an interaction between a computer-controlled machine 500 and control system 502. In an example, the control system 502 is configured to control the computer-controlled machine 500 by executing vision model in accordance with the principles of the present disclosure. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic, and motion sensors. In some embodiments, sensor 506 is an optical sensor configured to sense optical images of an environment proximate to computer-controlled machine 500. A vision model according to the present disclosure may perform pose estimation for the optical images as described herein.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to produce each input signal x. Input signal x may include data corresponding to an image recorded by sensor 506.

Control system 502 includes classifier 514. Classifier 514 may be configured to classify input signals x into one or more labels using a machine learning (ML) algorithm, such as a neural network. For example, the classifier 514 corresponds to the classifier 408 described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more anomaly detection methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 520, the computer-executable instructions of non-volatile storage 516 may cause control system 502 to implement one or more of the anomaly detection methodologies as disclosed herein. Non-volatile storage 516 may also include data supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. In an example, the control system 502 is configured to control the vehicle 600 by executing a vision model in accordance with the principles of the present disclosure. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the proximity of objects to vehicle 600, such as a pose estimation obtained by a vision model. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

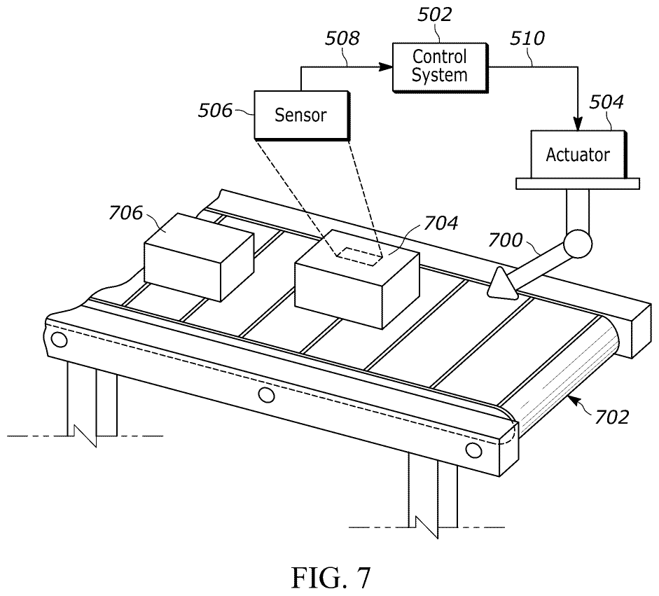

FIG. 7 depicts a schematic diagram of control system 502 configured to control system 700 (e.g., a manufacturing machine), such as a punch cutter, a cutter or a gun drill, of manufacturing system 702, such as part of a production line. Control system 502 may be configured to control actuator 504, which is configured to control system 700 (e.g., manufacturing machine). In an example, the control system 502 is configured to control the system 700 by executing a vision model in accordance with the principles of the present disclosure.

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

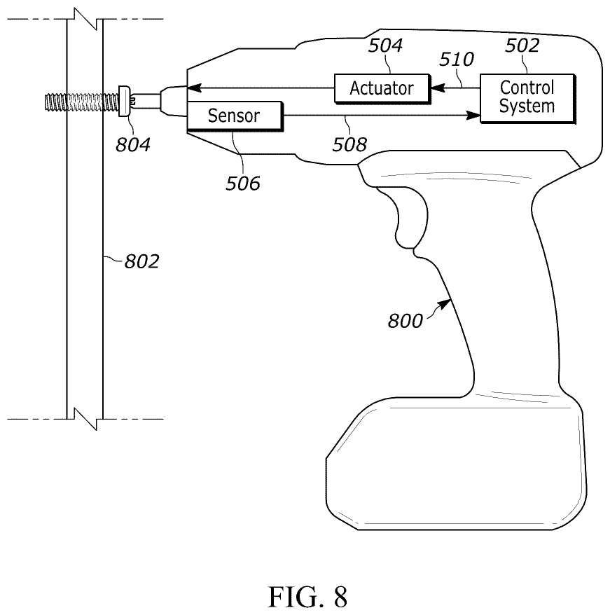

FIG. 8 depicts a schematic diagram of control system 502 configured to control power tool 800, such as a power drill or driver, that has an at least partially autonomous mode. Control system 502 may be configured to control actuator 504, which is configured to control power tool 800. In an example, the control system 502 is configured to control the power tool 800 by executing a vision model in accordance with the principles of the present disclosure.

Sensor 506 of power tool 800 may be an optical sensor configured to capture one or more properties of work surface 802 and/or fastener 804 being driven into work surface 802, which may include performing pose estimation using a vision model. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

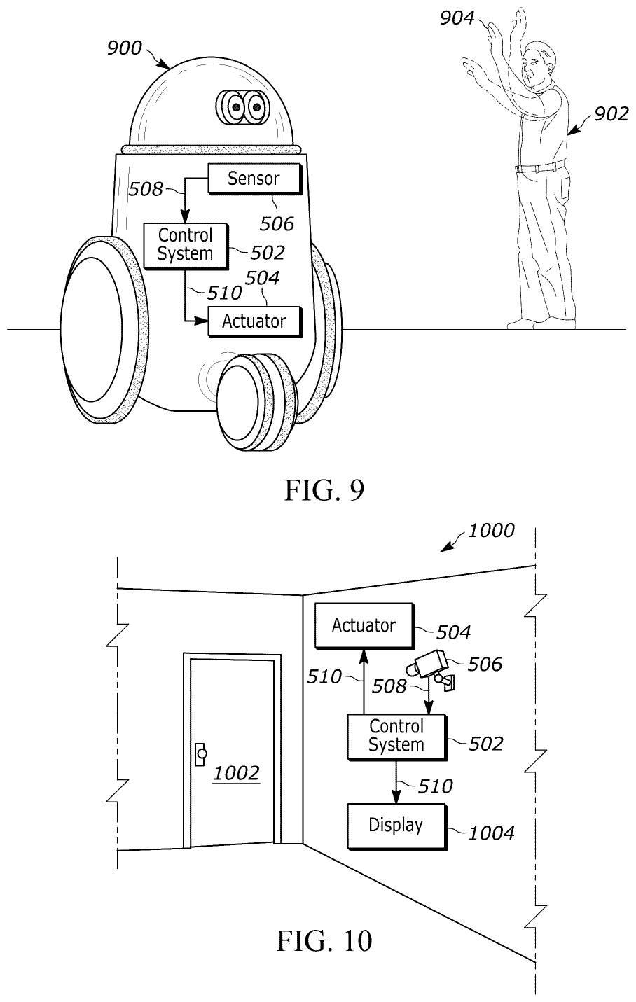

FIG. 9 depicts a schematic diagram of control system 502 configured to control an automated personal assistant 900 (e.g., a robot). Control system 502 may be configured to control actuator 504, which is configured to control automated personal assistant 900. Automated personal assistant 900 may be configured to control a domestic appliance, such as a washing machine, a stove, an oven, a microwave or a dishwasher. In an example, the control system 502 is configured to control the automated personal assistant 900 by executing a vision model in accordance with the principles of the present disclosure.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506, which may include performing pose estimation using a vision model. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face. In an example, the control system 502 is configured to control the monitoring system 1000 by executing a vision model in accordance with the principles of the present disclosure.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

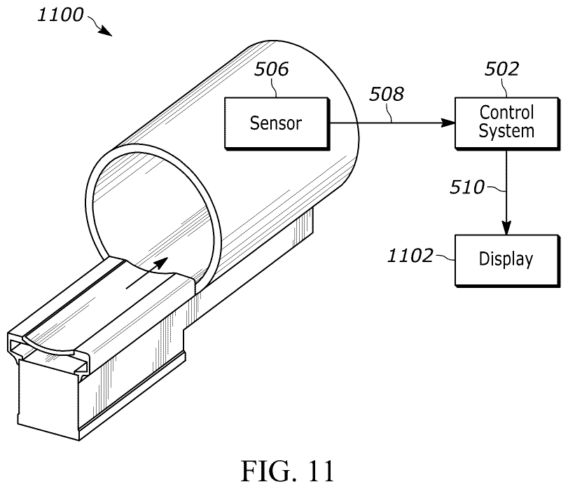

FIG. 11 depicts a schematic diagram of control system 502 configured to control imaging system 1100, for example an MRI apparatus, x-ray imaging apparatus or ultrasonic apparatus. In an example, the control system 502 is configured to control the imaging system 1100 by executing a vision model in accordance with the principles of the present disclosure. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of performing pose estimation for images, the method comprising, at one or more processing devices:
receiving an input image;
generating a pose code based on the input image, wherein the pose code corresponds to an estimate pose of an object in the input image;
generating a box code corresponding to a bounding box of the object in the input image;
performing pose estimation for the input image by generating a refined pose of the object using the pose code and the box code;
generating a prediction output for the object in the input image based on the input image and the refined pose; and
controlling one or more functions of a device based on the prediction output.

2. The method of claim 1, wherein generating the prediction output includes, (i) using an image encoder, generating a shape code and a texture code and (ii) generating the prediction output using the shape code, the texture code, and the refined pose.

3. The method of claim 2, wherein generating the prediction output includes generating the prediction output using a Neural Radiance Field (NeRF) decoder.

4. The method of claim 1, wherein generating the refined pose includes iteratively calculating the refined pose using the pose code and the box code.

5. The method of claim 4, further comprising iteratively updating the box code using the refined pose.

6. The method of claim 1, further comprising obtaining, using a multilayer perceptron, a pose loss based on the pose code.

7. The method of claim 1, wherein generating the prediction output includes converting the refined pose to a camera pose and generating the prediction output based on the camera pose.

8. A computing device configured to perform pose estimation for images, the computing device including a processing device configured to execute instructions stored in memory to:
receive an input image;
generate a pose code based on the input image, wherein the pose code corresponds to an estimate pose of an object in the input image;
generate a box code corresponding to a bounding box of the object in the input image;
perform pose estimation for the input image by generating a refined pose of the object using the pose code and a box code;
generate a prediction output for the object in the input image based on the input image and the refined pose; and
control one or more functions of a device based on the prediction output.

9. The computing device of claim 8, wherein generating the prediction output includes, (i) using an image encoder, generating a shape code and a texture code and (ii) generating the prediction output using the shape code, the texture code, and the refined pose.

10. The computing device of claim 9, wherein generating the prediction output includes generating the prediction output using a Neural Radiance Field (NeRF) decoder.

11. The computing device of claim 8, wherein generating the refined pose includes iteratively calculating the refined pose using the pose code and the box code.

12. The computing device of claim 11, wherein the processing device is configured to iteratively update the box code using the refined pose.

13. The computing device of claim 8, wherein the processing device is configured to obtain, using a multilayer perceptron, a pose loss based on the pose code.

14. The computing device of claim 8, wherein generating the prediction output includes converting the refined pose to a camera pose and generating the prediction output based on the camera pose.

15. A computer-controlled machine configured to operate in accordance with a pose estimation generated a vision model, the computer-controlled machine comprising:
a control system configured to
receive an input image captured by a camera,
generate a pose code based on the input image, wherein the pose code corresponds to an estimate pose of an object in the input image,
generate a box code corresponding to a bounding box of the object in the input image,
perform pose estimation for the input image by generating a refined pose of the object using the pose code and a box code,
generate a prediction output for the object in the input image based on the input image and the refined pose, and
output a control signal based on the prediction output; and
an actuator configured to control an operation of the computer-controlled machine based on the control signal.

16. The computer-controlled machine of claim 15, wherein generating the prediction output includes, (i) using an image encoder, generating a shape code and a texture code and (ii) generating the prediction output using the shape code, the texture code, and the refined pose.

17. The computer-controlled machine of claim 16, wherein generating the prediction output includes generating the prediction output using a Neural Radiance Field (NeRF) decoder.

18. The computer-controlled machine of claim 15, wherein generating the refined pose includes iteratively calculating the refined pose using the pose code and the box code.

19. The computer-controlled machine of claim 18, wherein the control system is further configured to iteratively update the box code using the refined pose.

20. The computer-controlled machine of claim 15, wherein the control system is further configured to obtain, using a multilayer perceptron, a pose loss based on the pose code.
